(19) United States
(12) Patent Application Publication
(10) Pub. No.: US 2010/0157889 A1
(43) Pub. Date: Jun. 24, 2010

(54) SYSTEM AND METHOD FOR IMPROVING EFFICIENCY OF BROADCAST COMMUNICATIONS IN A MULTI-HOP WIRELESS MESH NETWORK

(75) Inventors: Pankaj Aggarwal, Lake Mary, FL (US); Keith J. Goldberg, Casselberry, FL (US); Avinash Joshi, Lake Mary, FL (US); Manish Shukla, Altamonte Springs, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/338,053

(22) Filed: Dec. 18, 2008

(51) Int. Cl. H04W 40/02

(52) U.S. Cl. 370/328

(57) ABSTRACT

Systems and methods are provided for improving efficiency and reliability of broadcast transmission in a multi-hop wireless mesh communication network. When an intelligent access point (IAP) receives a broadcast packet (BP), the IAP can determine a list of downlink child mesh nodes (DLCMNs) of the IAP based on route information provided in its routing table. After the IAP knows its DLCMNs, the IAP can determine a first lowest data rate (LDR) between the IAP and each of its DLCMNs, and then re-transmit the BP at the first LDR. The BP is then received by at least one “parent” mesh node, which can then perform similar processing, and can then re-transmit the BP to its DLCMNs. This process repeats until the BP reaches a leaf mesh node. In other words, each mesh node can determine its DLCMNs, determine the LDR between itself and each of its DLCMNs, and can then re-transmit the BP at this LDR.

### RELATED APPLICATIONS

The present application is related to the following U.S. application commonly owned with this application by Motorola, Inc.: Ser. No. ______, filed Dec. 18, 2008, titled “System And Method For Improving Efficiency And Reliability Of Broadcast Communications In A Multi-Hop Wireless Mesh Network,” attorney docket no. CM12486 the entire contents of which being incorporated herein by reference.

### FIELD OF THE DISCLOSURE

The present disclosure relates generally to wireless communications and more particularly to broadcast communications within a multi-hop wireless mesh communication network.

### BACKGROUND

An infrastructure-based wireless network typically includes a communication network with fixed and wired gateways. Many infrastructure-based wireless networks employ a mobile unit which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, an ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network. Because the topology of an ad hoc network can change significantly techniques are needed which can allow the ad hoc network to dynamically adjust to these changes. Due to the lack of a central controller, many network-controlling functions can be distributed among the nodes such that the nodes can self-organize and reconfigure in response to topology changes.

One characteristic of the nodes is that each node can directly communicate over a short range with other nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. As used herein, the term “multi-hop network” refers to any type of wireless network which employs routing protocols among nodes that are part of a network. Nodes in a multi-hop network each have a routing module that manages routing. In such multi-hop networks, each intermediate node routes the packets (e.g., data and control information) to the next node along the route, until the packets reach their final destination. For relaying packets to the next node, each node maintains routing information collected through communication with neighboring nodes. The routing information and metrics can also be periodically broadcast in the network to reflect the current network topology. Alternatively, nodes may exchange routing information and metrics only when it is needed.

A wireless mesh network is a collection of wireless mesh nodes or devices organized in a decentralized manner to provide range extension by allowing mesh nodes to be reached across multiple hops. In a wireless mesh multi-hop network, communication packets sent by a source mesh node can be relayed through one or more intermediary nodes before reaching a destination mesh node. In addition, some wireless mesh multi-hop networks employ one or more special mesh nodes, referred to as intelligent access points (IAP) that are coupled to a wired network. An IAP can provide other mesh nodes with access to the wired network.

Broadcasting information in a conventional multi-hop wireless mesh communication network can be inefficient and/or unreliable in many scenarios.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a multi-hop wireless mesh communication network;

FIG. 2 illustrates the multi-hop wireless mesh communication network of FIG. 1 with various mesh nodes arranged in a tree architecture with examples data rates between each mesh node and each of its downlink child mesh nodes;

FIG. 3 is a simplified block diagram which illustrates an exemplary mesh node in accordance with some embodiments;

FIG. 4 is a table illustrating a portion of a routing table maintained by a mesh node or IAP in accordance with some embodiments;

FIG. 5 is flow chart illustrating a method performed at an IAP for improving efficiency and reliability of broadcast transmission in a multi-hop wireless mesh communication network in accordance with some embodiments; and

FIG. 6 is flow chart illustrating a method performed at an intermediate mesh node and at a leaf mesh node for improving efficiency and reliability of broadcast transmission in a multi-hop wireless mesh communication network in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

According to one embodiment, a method for communicating a broadcast packet in a multi-hop wireless mesh communication network is provided. The multi-hop wireless mesh communication network can include an intelligent access point (IAP), and a plurality of mesh nodes. The IAP maintains a first routing table comprising a plurality of first route entries, and first route information for each first route entry. When the IAP receives a broadcast packet that is destined for other mesh nodes in the multi-hop wireless mesh communication network, the IAP adds a first unique broadcast identifier (ID) to the broadcast packet. The IAP can determine a list of downlink child mesh nodes of the IAP based on the first route information provided in the first routing table that is stored at the IAP. In one implementation, the first route information for each of the first route entries comprises: a destination address of a destination node of the broadcast packet, a next hop address of a next hop node to reach the destination node, an indicator that indicates whether the destination address of the destination node is that of an IAP, an indicator that indicates whether the destination address of the destination node is that of a leaf mesh node, and a data rate to the next hop node that provides the data rate over the mesh communication links between the IAP and the next hop node towards the destination node. In one implementation, the IAP can determine the list of downlink child mesh nodes of the IAP by determining the next hop nodes specified in the first routing table since these are “the list of downlink child mesh nodes of the IAP.” After the IAP knows its downlink child mesh nodes, the IAP can determine a first lowest data rate between the IAP and each of the downlink child mesh nodes of the IAP, and then re-transmit the broadcast packet at the first lowest data rate. The broadcast packet is then received by at least one “parent” mesh node, which can then perform similar processing to that described above by the IAP, and can then re-transmit the broadcast packet to its downlink child mesh nodes at a lowest data rate between the parent mesh node and each of the downlink child mesh nodes including a “current child mesh node” of the parent mesh node.

The current child mesh node maintains a second routing table comprising a plurality of second route entries, and second route information for each second route entry. The second route information for each second route entry comprises: a destination address of a destination node of the broadcast packet, a next hop address of a next hop node to reach the destination node, an indicator that indicates whether the destination address of the destination node is that of an IAP, an indicator that indicates whether the destination address of the destination node is that of a leaf mesh node, a data rate to the next hop node that provides the data rate over the mesh communication links between the current child mesh node and the next hop node towards the destination node, and a precursor list that maintains information regarding the list of nodes that are using the current child mesh node to reach the destination node that is specified by the destination address for each particular second route entry. The precursor list route entry corresponding to the IAP specifies a list of downlink child mesh nodes of the current child mesh node.

After receiving the broadcast packet from the parent mesh node, the current child mesh node can determine whether it is a leaf mesh node. In one implementation, the current child mesh node can make this determination by looking up a second route entry for the IAP in the second routing table of the current child mesh node, determining whether a precursor list corresponding to the second route entry for the IAP specifies nodes, and when the precursor list corresponding to the second route entry for the IAP specifies at least one node, the current child mesh node determines that it is not a leaf mesh node. When the current child mesh node determines that it is not a leaf mesh node, it determines its downlink child mesh nodes (i.e., downlink child mesh nodes of the current child mesh node). In one implementation, the current child mesh node can determine its downlink child mesh nodes by looking up a second route entry for the IAP in the second routing table, and determining nodes listed in a precursor list corresponding to the second route entry for the IAP. The nodes listed in the precursor list corresponding to the second route entry for the IAP are downlink child mesh nodes of the current mesh node. After the current child mesh node has determined its downlink child mesh nodes, the current child mesh node can determine the lowest data rate between itself and each of its downlink child mesh nodes, and can then re-transmit the broadcast packet at this lowest data rate.

According to other embodiments, a method for acknowledging reception of a broadcast packet in a multi-hop wireless mesh communication network is provided. The multi-hop wireless mesh communication network can include an intelligent access point (IAP) and a plurality of mesh nodes including a parent mesh node, a child mesh node and at least one leaf mesh node. As described above, when the IAP receives the broadcast packet it adds a first unique broadcast identifier (ID) to the broadcast packet at the IAP, and transmits the broadcast packet at a lowest data rate between the IAP and each of the downlink child mesh nodes of the IAP, these downlink child mesh nodes eventually can then become parent mesh nodes for their child mesh nodes (if any), repeat processing similar to that performed by the IAP, and retransmit the broadcast packet to their downlink child mesh nodes at a lowest data rate of their downlink child mesh nodes.

Upon receiving the broadcast packet from a parent mesh node, a child mesh node determines whether it is a leaf mesh node. To do so, the child mesh node can look up a route entry for the IAP in its routing table, and determine whether any nodes are specified in a precursor list corresponding to the route entry for the IAP. When the precursor list for the IAP does not specify any nodes, the child mesh node determines that it is a leaf mesh node. By contrast, when the precursor list for the IAP specifies at least one node the child mesh node determines that it is not a leaf mesh node.

When the child mesh node determines that it is a leaf mesh node, the leaf mesh node (previously referred to as the child mesh node) determines a route from the leaf mesh node to the IAP, and unicasts an acknowledgement (ACK) message, which includes the first unique broadcast ID from the broadcast packet, along the route towards the IAP. When an intermediate mesh node along the route between the leaf mesh node and the IAP receives the acknowledgement (ACK) message from the leaf mesh node, it compares the first unique broadcast identifier (ID) therein to a list of previously received broadcast identifiers (IDs) that the intermediate mesh node has determined from broadcast packets that it previously received and stored in memory. Based on the comparison of the first unique broadcast identifier (ID) to the previously received broadcast identifiers, the intermediate mesh node determines whether the intermediate mesh node has previously received the broadcast packet having the first unique broadcast identifier (ID). When the intermediate mesh node has not previously received a broadcast packet having the first unique broadcast identifier (ID), the intermediate mesh node drops the ACK message. When the intermediate mesh node has previously received a broadcast packet having the first unique broadcast identifier (ID), the intermediate mesh node forwards the ACK message to a next hop mesh node along the route to the IAP. Each intermediate mesh node along the route between the leaf mesh node and the IAP performs the same processing upon receiving the ACK message.

By contrast, when the child mesh node determines that it is not a leaf mesh node, the child mesh node determines its downlink child mesh nodes, and another lowest data rate between itself and each of its downlink child mesh nodes. The child mesh node then re-transmits the broadcast packet at this other lowest data rate. In one implementation, the child mesh node can determine its downlink child mesh nodes by reading a route entry for the IAP in its routing table and determines nodes listed in a precursor list of the route entry for the IAP. The downlink child mesh nodes of the mesh node are nodes listed in the precursor list of the route entry for the IAP.

According to still other embodiments, the IAP can also determine whether to re-communicate the broadcast packet that it had previously re-transmitted to each of its downlink child mesh nodes at the first lowest data rate. To explain further, the IAP maintains a list of the leaf mesh nodes, and when the IAP re-transmits the broadcast packet, it starts acknowledgement (ACK) timers for each of the leaf mesh nodes in its list. The IAP then selects a selected leaf mesh node from its list, and determines whether an acknowledgement (ACK) timer for the selected leaf mesh node has expired. When the acknowledgement (ACK) timer has expired, the IAP determines whether an explicit acknowledgement (ACK) message was received from the selected leaf mesh node, and if so, the IAP explicitly determines that the broadcast packet was successfully delivered to the selected leaf mesh node and implicitly determines that the broadcast packet was successfully delivered to each of the other mesh nodes along a branch between the IAP and the selected leaf mesh node. By contrast, when an explicit acknowledgement (ACK) message was not received from the selected leaf mesh node, the IAP can unicast a special copy of the broadcast packet towards the selected leaf mesh node.

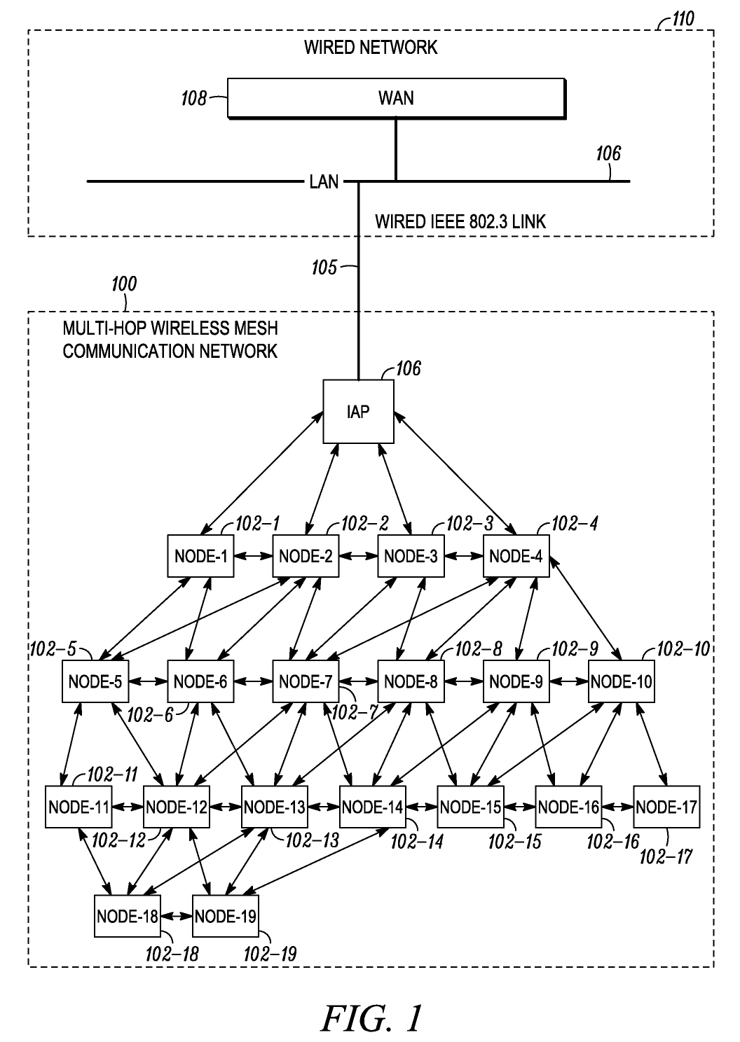

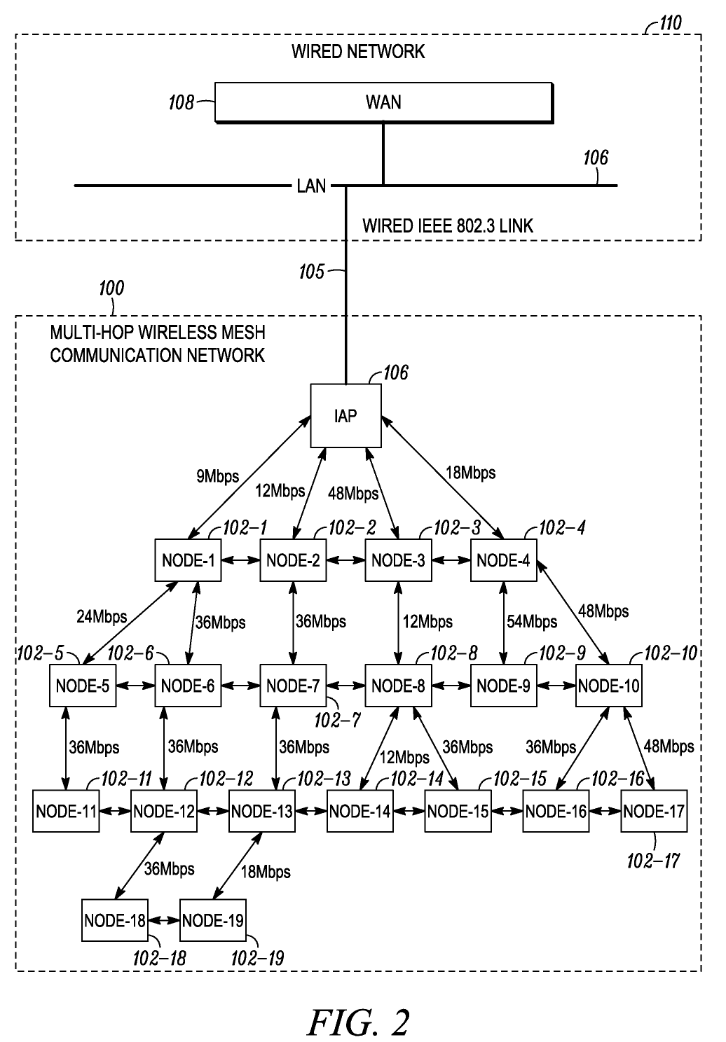

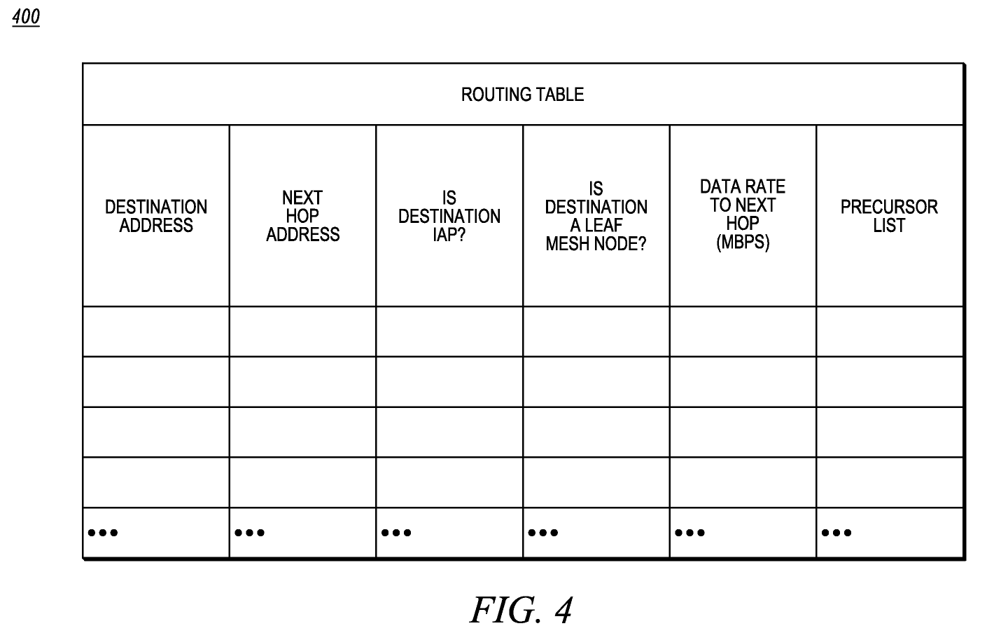

Prior to describing some embodiments with reference to FIGS. 4-6, an example of an example multi-hop wireless mesh communication network configuration in which these embodiments can be applied will now be described with reference to FIGS. 1 and 2.

### Network

FIG. 1 illustrates a multi-hop wireless mesh communication network 100. The communication network 100 can be a mesh enabled architecture (MEA) network, an IEEE 802.11 network (i.e. 802.11a, 802.11b, 802.11g, 802.11e or 802.11s), or any other packetized mesh communication network. As used herein, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.

As illustrated in FIG. 1, the multi-hop wireless mesh communication network 100 includes a plurality of mesh-enabled nodes 102-1 through 102-19 (referred to generally as mesh nodes 102), and an intelligent access point (IAP) 106. The exemplary multi-hop mesh network 100 is illustrated as including one IAP 106 and a plurality of mesh nodes 102; however, it will be appreciated that more than one IAP may be present and that additional or fewer mesh nodes 102 can be present in a particular multi-hop mesh network. The IAP 106 provides mesh nodes 102 with access to a fixed network 110 via a wired network interface 105 (e.g., an IEEE 802.3 interface). The fixed network 110 can include, for example, a core local access network (LAN) 106, and/or a wide area network (WAN) 108. The WAN 108 can include an IP network or network(s) that can include devices such as servers and gateway routers to provide access to other networks, such as, other IP networks, ad-hoc networks, a public switched telephone network (PSTN) and the Internet.

### Mesh Node

The mesh nodes 102 are communication devices that can be fixed, potentially mobile or mobile. As used herein, the term “mesh node” refers to a wireless communication device which has mesh routing capability meaning that a mesh node has routing functionality and can route traffic to and from other nodes with routing functionality. The mesh nodes 102 can each act as wireless routers and route data packets between other mesh nodes 102, and the IAP 106. As such, any two mesh nodes 102 (and/or IAP 106) are capable of communicating with each other directly or indirectly. When communicating indirectly, mesh nodes 102, can operate as routers for forwarding or relaying packets being sent between mesh nodes. Routing functionality provided in the mesh nodes 102 allows the mesh nodes 102 to determine the path of least resistance through a mesh network 100. In some cases, this can be the path characterized by the least number of hops to the destination. As will be described below, each of the mesh nodes 102-1 through 102-19 regularly exchange routing information and switching table information with all peer/neighbor mesh-enabled nodes and the IAP 106.

### Intelligent Access Point (IAP)

An IAP is a special mesh node that has a wired network connection 105, such as a wired 802.3 link, to a fixed wired network 110. An IAP is distinguishable from a regular AP in that a mesh node implements a mesh routing protocol, such as the Mesh Scalable Routing (MSR) protocol disclosed in U.S. Pat. No. 7,061,925 B2, entitled “System and Method for Decreasing Latency in Locating Routes Between Nodes in a Wireless Communication Network” assigned to the assignee of the present invention, its contents being incorporated by reference in its entirety herein, and/or MSR's proxy routing variant as described in United States published patent application 20060098612, filed Sep. 7, 2005, entitled “System and method for associating different types of nodes with access point nodes in a wireless network to route data in the wireless network”, and United States published patent application 20060098611, filed Sep. 7, 2005, entitled “System and method for routing data between different types of nodes in a wireless network.” As used herein, the term “intelligent access point (IAP)” refers to any type of access point device that is: (1) connected to a fixed wired network 110 to enable remote mesh nodes to communicate with the fixed wired network 110 (e.g. local area network (LAN) 106, wide area network (WAN) 108, etc.) and (2) designed to establish and maintain mesh communication links with other mesh nodes, has mesh routing capability and can perform forwarding and/or relaying and/or repeating and/or routing for other mesh nodes. An IAP communicates over wireless mesh network interfaces with other mesh nodes and can act as an access point for those devices. An IAP can route packet(s), including packet(s) generated by a non-mesh or non-routable device associated with it, to the correct remote destination which can be a routable or another non-routable device. In addition to having wireless mesh interfaces to other mesh nodes, a IAP is a mesh-enabled access point (MAP) which has a wired network interface and is coupled to wired connection. A IAP provides other devices with a path for packets to a wired network and possibly with access to a wide area wired network (WAN) and other network appliances (e.g., servers, gateway devices, etc.) that are part of the WAN. A IAP can relay packets between the wireless devices and the wired devices on the wired network or WAN. Thus, a network of IAPs and mesh nodes can enable communication between the wired network and remote wireless nodes which are multiple hops away from the wired network.

### Routing

As used herein the term “mesh routing algorithm” or “mesh routing protocol” refers to a protocol used by a mesh routing module to determine the appropriate path or route over which data is transmitted. The mesh routing protocol also specifies how nodes in a communication network share information with each other and report changes. The mesh routing protocol enables a network to make dynamic adjustments so that routing decisions do not have to be predetermined and static. A mesh routing protocol controls how nodes come to agree which way to route packets between the nodes and other computing devices in a network. Examples of some ad hoc routing protocols include, for example, protocols, such as, the Ad hoc On-demand Distance Vector (AODV) routing protocol, the Dynamic Source Routing (DSR) protocol, and the Mesh Scalable Routing (MSR) protocol. Any mesh routing algorithm or protocol (or combination thereof) can be used in conjunction with the embodiments described herein. There are hundreds (or more) of existing ad hoc routing protocols.

As will be appreciated by those skilled in the art, mesh routing protocols can be used to create routes through a mesh network using both proactive routing and/or on-demand routing. In proactive routing, an IAP can be configured as a network root. The IAP sends periodic portal announcement messages that are forwarded hop-by-hop through the network, and waits to hear announcement messages from other mesh nodes. As will be described below, each mesh node creates a tree-structured routing table based on metrics from the root announcement messages received from neighboring mesh nodes. By contrast, on-demand routing can be used to find a destination node when there is no proactive route to the destination node. A source mesh node sends requests for the destination node to neighboring mesh nodes. The requests are forwarded along until one reaches the destination node, at which time the destination node then sends a response that is forwarded back to the source mesh node.

As used herein, the term “Ad hoc On-demand Distance Vector (AODV)” refers to a routing protocol for ad hoc mobile networks with large numbers of mobile nodes. The AODV protocol is defined in RFC 3561 by C. Perkins, E. Belding-Royer, and S. Das, “Ad hoc On-Demand Distance Vector (AODV) Routing”, http://www.rfc-editor.org/rfc/rfc3561.txt. In this routing protocol, when a portal node, for example, an Intelligent Access Point (IAP), is present in the network, each node with meshing capability proactively maintains the route to the IAP and dynamically sets up at least one route to other peers when the routes are needed. The protocol's algorithm creates routes between nodes only when the routes are requested by the source nodes, giving the network the flexibility to allow nodes to enter and leave the network at will. Routes remain active only as long as data packets are traveling along the paths from the source to the destination. When the source stops sending packets, the path will time out and close.

### Tree Structure

As noted above, in many proactive routing protocols, routing modules of the IAP 106 and mesh nodes 102-1 . . . 102-19, create a tree-structured routing tables based on metrics from the root announcement messages received from neighboring mesh nodes. An example of a tree that is created by a routing module will now be described with reference to FIG. 2.

FIG. 2 illustrates the multi-hop wireless mesh communication network 100 of FIG. 1 with various mesh nodes arranged in a tree architecture with examples data rates between each mesh node and each of its downlink child mesh nodes.

Within a multi-hop wireless mesh communication network 100, a routing module within the IAP 106 can arrange or structure the set of linked mesh nodes 102-1 through 102-19 into a hierarchical or “tree” like structure (called a “tree” hereinafter). The tree structure describes “active” routes that will have user data transferred over them (as opposed to all possible routes amongst nodes). The topmost mesh node in the tree is called the root mesh node, which in this context is an IAP 106. A tree generally includes the IAP 106 and at least one child mesh node of the IAP 106. A tree includes one or more branches that grow downward from the IAP 106, where a branch is a distinct path between the IAP 106 and various leaf mesh nodes. In most cases the tree will include multiple branches. In each branch, one or more intermediate child mesh nodes link the IAP 106 to a leaf mesh node. As used herein, the term “leaf mesh node” or “terminal mesh node” refers to a mesh node of a tree that has zero child nodes. In other words, mesh nodes at the bottommost level of the tree are called leaf mesh nodes. In the particular example illustrated in FIG. 8, the tree includes eight leaf mesh nodes 102-11, 102-18, 102-19, 102-14, 102-15, 102-9, 102-16, 102-17 and thus eight distinct branches. As illustrated in FIG. 1, in many cases a leaf mesh nodes are the nodes farthest from a root node (e.g., IAP).

A sub-tree is a portion of a tree that can be viewed as a complete tree in itself. Any mesh node in a tree together with all the mesh nodes below it comprise a sub-tree. The sub-tree corresponding to the root mesh node is the entire tree; the sub-tree corresponding to any other mesh node and can be referred to as a proper sub-tree. Every mesh node in a tree can be seen as the root mesh node or parent mesh node of any sub-tree rooted at that mesh node.

As used herein, the term “parent mesh node” refers to a mesh node that has one or more child mesh nodes, and the term “child mesh node” refers to a mesh node that has a direct communication link to a parent mesh node. Thus, a mesh node that has a child is called the child's parent mesh node. In the examples described below a parent is a next hop node that goes towards the IAP and a child is a next hop node that flows away from the IAP. For example, in the exemplary multi-hop wireless mesh communication network 100 illustrated in FIG. 2, the IAP 106 has four downlink child mesh nodes: mesh node 102-1, mesh node 102-2, mesh node 102-3 and mesh node 102-4. Throughout this document, the terms “downlink” and “downstream” can be used interchangeably. It should be noted that the IAP 106 does not have a parent mesh node since it is the “root” or topmost mesh node. To illustrate further, mesh node 102-3 would be the parent mesh node of mesh node 102-8, but would be a child mesh node of IAP 106.

Any given parent mesh node can be associated with multiple branches, and can be wirelessly linked to one or more leaf mesh nodes by one or more intermediate child mesh nodes. For example, mesh node 102-3 is the “parent” of child mesh node 102-8, which in turn the parent of child mesh nodes 102-14 and 102-15. An intermediate, inner or internal mesh node is a mesh node of a tree between the root mesh node and the leaf mesh nodes. An intermediate mesh node has at most one parent mesh node and has one or more child mesh nodes (and is thus not a leaf mesh node), which are below it in the tree. For example, with respect to leaf mesh nodes 102-14, 102-15, mesh nodes 102-3, 102-8 are intermediate mesh nodes since they are part of the branch that links leaf mesh nodes 102-14, 102-15 to IAP 106.

In the exemplary multi-hop wireless mesh communication network 100 illustrated in FIG. 2, a specific example of the data rates over the mesh communication links between the IAP 106 and mesh node 102-1, mesh node 102-2, mesh node 102-3 and mesh node 102-4 are 9 megabits per second, 12 megabits per second, 48 megabits per second and 18 megabits per second, respectively. The data rates along the links between parent mesh node 102-1 and its child mesh nodes 102-5 and 102-6 are 24 megabits per second and 36 megabits per second, respectively. The data rate along the link between parent mesh node 102-2 and its child mesh node 102-7 is 36 megabits per second. The data rate along the link between parent mesh node 102-3 and its child mesh node 102-8 is 12 megabits per second. The data rates along the links between parent mesh node 102-4 and its child leaf mesh node 102-9 and child mesh node 102-10 are 54 megabits per second and 48 megabits per second, respectively. The data rate along the link between parent mesh node 102-5 and its child leaf mesh node 102-11 is 36 megabits per second. The data rate along the link between parent mesh node 102-6 and its child mesh node 102-12 is 36 megabits per second. The data rate along the link between parent mesh node 102-7 and its child mesh node 102-13 is 36 megabits per second. The data rates along the links between parent mesh node 102-8 and its child leaf mesh nodes 102-14 and 102-15 are 12 megabits per second and 36 megabits per second, respectively. The data rates along the links between parent mesh node 102-10 and its child leaf mesh nodes 102-16 and 102-17 are 36 megabits per second and 48 megabits per second, respectively. The data rate along the link between parent mesh node 102-12 and its child leaf mesh node 102-18 is 36 megabits per second. The data rate along the link between parent mesh node 102-13 and its child leaf mesh node 102-19 is 18 megabits per second.

### Broadcast Communications in a Multi-Hop Wireless Mesh Communication Network

Many conventional multi-hop wireless mesh communication networks allow for broadcast communications. A broadcast packet that is to be communicated to mesh nodes in the multi-hop wireless mesh communication network can be generated by or “originate from” either: (1) a mesh node 102 that is part of the multi-hop wireless mesh communication network 100 or (2) an external computing node that is part of the wired network 110.

Broadcast traffic originating from outside the wired network 110 is injected into the multi-hop wireless mesh communication network 100 by the IAP 106, and can easily follow a tree structure known by the IAP 106 from its routing module. A single broadcast message is transmitted multiple times in a multi-hop wireless mesh communication network due to the multi-hopping nature of a mesh. In one implementation like MSR, IAP tags each broadcast packet originated from outside wired network with unique identifier called sequence number before broadcasting it within the downstream mesh nodes. For a given broadcast packet, sequence numbers generated by one IAP 106 will have no correlation to sequence numbers generated by another IAP, hence a mesh node can only accept broadcast packets from the TAP they are bound or associated. Broadcasting information in a multi-hop wireless mesh communication network 100 can be problematic in some situations.

One such problem relates to the substantial amount of overhead information that is transmitted to propagate a broadcast message throughout the multi-hop wireless mesh communication network 100. For example, when a message is broadcast by a source mesh node in a multi-hop wireless mesh communication network 100, it is received by first hop neighbor mesh nodes of the source mesh node, and then retransmitted or “repeated” by the first hop neighbor mesh nodes. Each mesh node that receives the transmitted message then retransmits the message to its first hop neighbor mesh nodes. This retransmission process repeats until each mesh node in the multi-hop wireless mesh communication network 100 has re-broadcasted or transmitted the broadcast message one time. In other words, the broadcast message is “flooded” throughout the multi-hop wireless mesh communication network 100. This is problematic since many mesh nodes will unnecessarily receive redundant copies of the broadcast message. The redundant or duplicate copies of the broadcast message are identified by sequence number in the broadcast message. This results in a lot of unnecessary overhead that could otherwise be avoided. When there is a significant amount of broadcast traffic in the multi-hop wireless mesh communication network 100, this flooding technique can sometimes cause the multi-hop wireless mesh communication network 100 to fail.

With broadcast communications in a conventional multi-hop wireless mesh communication network, there is also a trade off between data rate and ensuring reliable transmission.

Because packets travel farther at lower data rates, according to one conventional approach, the source mesh node typically transmits its broadcast packet at a system minimum data rate to try and ensure that as many of the mesh nodes 102-1 . . . 102-19 as possible receives the broadcast packet. For instance, in an IEEE 802.11b network, the system minimum data rate also known as BSS Basic Rate Set can be 1 or 2 megabits per second, whereas in an IEEE 802.11a network, the system minimum data rate can be 6 megabits per second. Each mesh node 102-1 . . . 102-19 that receives the broadcast packet then repeats the transmission at the system minimum data rate. Because each mesh node that transmits or retransmits the broadcast message typically does so at the lowest data rate, each transmission or retransmission uses more channel time than necessary. For instance, in the example network illustrated in FIG. 1, for each broadcast message transmitted by IAP 106, each mesh node 102-1 through 102-19 will retransmit broadcast message, and there will be 20 transmissions of the broadcast message. If the broadcast message is a 1000 byte data packet and the lowest data rate is 6 megabits per second (and each of these transmissions is at this lowest data rate), then there will be 20 transmissions of the 1000 byte packet at a rate of 6 Mbps. As will be appreciated, this problem would be even more pronounced, for example, in a mixed IEEE 802.11b/g multi-hop wireless mesh communication network, where the lowest data rate for the broadcast transmissions will be 1 megabit per second, even though data rate over individual links between mesh nodes could be as high as 54 megabits per second.

Thus, although sending broadcast traffic at the system minimum data rate tends to ensure reliable transmission (i.e., that each mesh node receive a copy of the broadcast packet), broadcasting at the system minimum data rate results in an inefficient channel usage and significant redundancy since mesh nodes tend to receive the same broadcast packet from multiple sources multiple times. It would be desirable to better use the available channel capacity of these individual links.

Another problem relates to the unreliability of such broadcast transmissions in the multi-hop wireless mesh communication network 100. When a broadcast message is transmitted by the source mesh node, it is desirable for the source mesh node to know if the broadcast message was successfully received by each of the individual mesh nodes throughout the multi-hop wireless mesh communication network 100. Traditional broadcast messages are not acknowledged by recipient or “receiving” nodes. Lack of acknowledgement mechanisms makes the system unreliable since the source node has no way of knowing if all receiving nodes received the broadcast message. In addition, there are no retry mechanisms. In other words, the source node assumes that all receiving stations receive the broadcast message and does not attempt to retransmit it as in case of unicast message. Instead the source merely relies or depends on redundant broadcasts of the broadcast message by other nodes to help ensure reliability, but this is both inefficient and has minimal reliability. For example, a leaf node connected to the network through an intermediate node may completely miss the broadcast message transmitted from the intermediate node and neither the source node nor the leaf node have anyway of knowing that the leaf node did not receive the broadcast message.

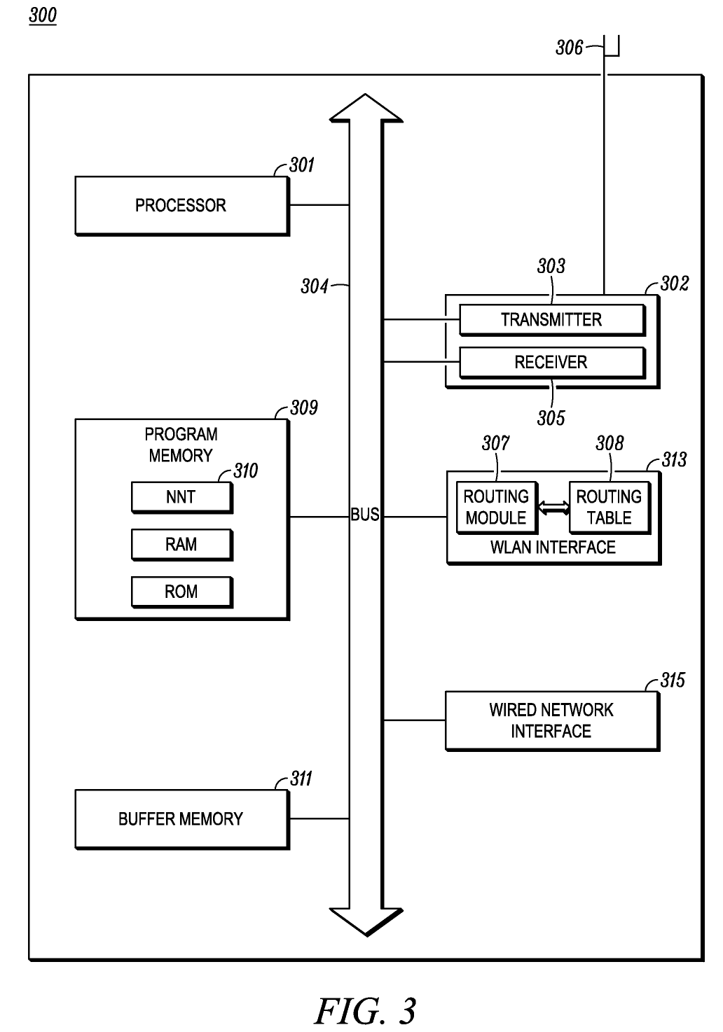

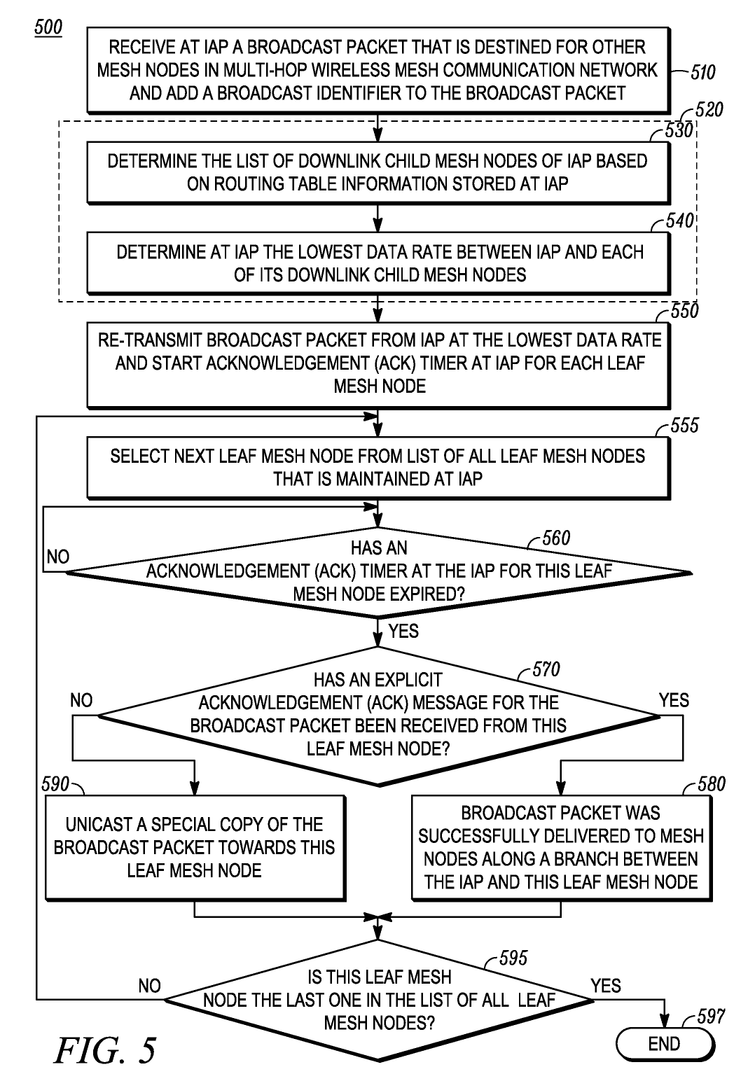

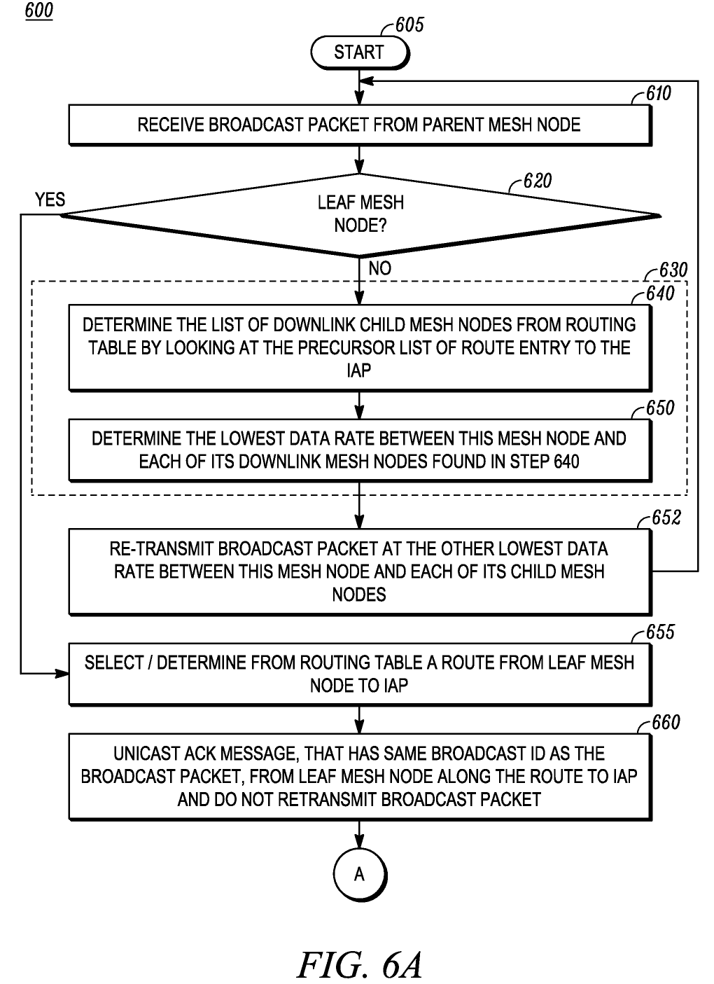

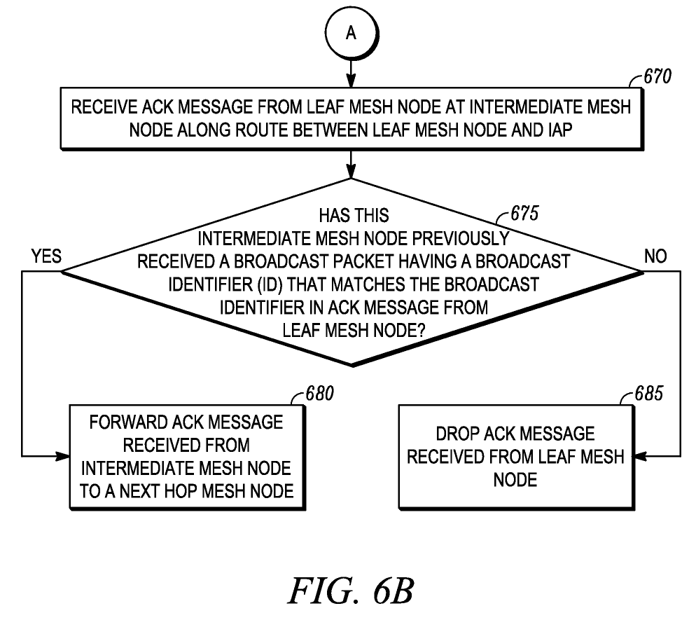

Thus, there is a need for methods and systems for improved broadcast transmissions within a multi-hop wireless mesh communication network. For instance, it would be desirable to provide methods and systems for improved broadcast transmissions within a multi-hop wireless mesh communication network that exhibit improved efficiency (e.g., better use the available channel capacity along individual links between mesh nodes) and/or that exhibit improved reliability. Prior to describing some embodiments with reference to FIGS. 5 and 6, an example of a mesh node in which these embodiments can be applied will now be described with reference to FIG. 3.

FIG. 3 is a simplified block diagram which illustrates an exemplary mesh node 200 in accordance with some embodiments. The mesh node can be one of the mesh nodes 102 or an Intelligent Access Point 106. In the description that follows, the mesh node 200 will be referred to as a mesh node 200; however, as described above, it will be appreciated that the mesh node 200 can also be An IAP if it has a wired network interfaces that is coupled to a wired connection.

The mesh node 200 comprises a processor 201, a transceiver 202 including a transmitter circuitry 203 and a receiver circuitry 205, an antenna 206, a program memory 209 for storing operating instructions that are executed by the processor 201, a buffer memory 211, and one or more communication interfaces including at least one wireless local area network (WLAN) interface 213 comprising a routing module 207 and a routing table 208, and at least one wired network interface 215 (e.g., an IEEE 802.3 interface). Although not shown, the mesh node 200 also can include an antenna switch, duplexer, circulator, or other highly isolative means (not shown) for intermittently providing information packets from the transmitter circuitry 203 to the antenna 206 and from the antenna 206 to the receiver circuitry 205. The mesh node 200 is an integrated unit containing at least all the elements depicted in FIG. 3, as well as any other elements necessary for the mesh node 200 to perform its particular electronic function. Alternatively, the mesh node 200 can comprise a collection of appropriately interconnected units or devices, wherein such units or devices perform functions that are equivalent to the functions performed by the elements of the mesh node 200.

The processor 201 includes one or more microprocessors, microcontrollers, DSPs (digital signal processors), state machines, logic circuitry, or any other device or devices that process information based on operational or programming instructions. Such operational or programming instructions are stored in the program memory 209. The program memory 209 can be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card, external subscriber identity module (SIM) card or any other medium for storing digital information. One of ordinary skill in the art will recognize that when the processor 201 has one or more of its functions performed by a state machine or logic circuitry, the memory 209 containing the corresponding operational instructions can be embedded within the state machine or logic circuitry. The operations performed by the processor 201 and the other elements of the mesh node 200 are described in detail below.

The transmitter circuitry 203 and the receiver circuitry 205 enable the mesh node 200 to communicate information packets to and acquire information packets from the other nodes. In this regard, the transmitter circuitry 203 and the receiver circuitry 205 include appropriate, conventional circuitry to enable digital or analog transmissions over a wireless communication channel. The transmitter circuitry 203 and the receiver circuitry 205 can operate over an ad hoc networking air interface (e.g., IEEE 802.11 (any variant), IEEE 802.15, and the like).

The implementations of the transmitter circuitry 203 and the receiver circuitry 205 depend on the implementation of the mesh node 200. For example, the transmitter circuitry 203 and the receiver circuitry 205 can be implemented as an appropriate wireless modem, or as conventional transmitting and receiving components of two-way wireless communication devices. In the event that the transmitter circuitry 203 and the receiver circuitry 205 are implemented as a wireless modem, the modem can be internal to the mesh node 200 or insertable into the mesh node 200 (e.g., embodied in a wireless radio frequency (RF) modem implemented on a Personal Computer Memory Card International Association (PCMCIA) card). For a wireless communication device, the transmitter circuitry 203 and the receiver circuitry 205 are preferably implemented as part of the wireless device hardware and software architecture in accordance with known techniques. One of ordinary skill in the art will recognize that most, if not all, of the functions of the transmitter circuitry 203 and/or the receiver circuitry 205 and/or WLAN interface 213 and/or wired network interface 215 can be implemented in a processor, such as the processor 201. However, the processor 201, the transmitter circuitry 203, the receiver circuitry 205, WLAN interface 213 and wired network interface 215 have been artificially partitioned herein to facilitate a better understanding.

The receiver circuitry 205 is capable of receiving radio frequency (RF) signals from at least one frequency band and optionally multiple frequency bands. The receiver circuitry 205 can optionally comprise a first receiver and a second receiver, or one receiver capable of receiving in two or more frequency bands. The receiver 205, depending on the mode of operation, can be tuned to receive, for example, wireless local area network (WLAN), such as IEEE 802.11, communication signals. The transceiver 202 includes at least one set of transmitter circuitry 203. The at least one transmitter 203 can be capable of transmitting to multiple devices potentially in multiple frequency bands.

The antenna 206 comprises any known or developed structure for radiating and receiving electromagnetic energy in the frequency range containing the wireless carrier frequencies.

The buffer memory 211 can be any form of volatile memory, such as random access memory (RAM), and is used for temporarily storing received information packets in accordance with the present invention.

As illustrated in FIG. 3, the routing module 207 and the routing table 208 are communicatively coupled, and located within the WLAN interface 213. However, in some implementations, the routing table 208 can be maintained by the routing module 207 and stored in memory 209.

When a mesh node detects the presence of a neighbor mesh node within its communication range, for example, by receiving a management frame, beacon or other regularly transmitted or periodic message such as a presence message or HELLO message, the routing module 207 of the mesh node 200 can add the neighbor mesh node to a neighbor mesh node table 210 by populating the neighbor mesh node table 210 with information about the neighbor mesh node. Depending upon the implementation, some examples of some of the attributes stored in the neighbor mesh node table include a neighbor mesh node list, an active route list and a proxy list, and parameters such as Link Quality Measurements (LQMs) (which account for the quality of a wireless link with the particular neighbor mesh node), routing metrics (which account for metrics along a route to the particular neighbor mesh node), mobility domain information comprising a mobility domain value advertised by the particular neighbor mesh node, mobility information about the particular neighbor mesh node (e.g., fixed or mobile); and security association state information regarding whether or not a security association is already established with a neighbor mesh node.

In one embodiment, in addition to performing routing functions, the routing module 207 may also control information that is entered into the routing table 208.

FIG. 4 illustrates a portion of a routing table 400 maintained by a mesh node or IAP in accordance with an embodiment. As illustrated in FIG. 4, the routing table includes a plurality of rows, where each row is a “route entry,” and a plurality of columns that specify route information for each route entry. In this particular example, the route information specified for each route entry includes: a destination address (e.g. MAC address or IP address) of a destination node of the broadcast message, a next hop address of a next hop node to reach the destination node, an indicator that indicates whether the destination node (column 1) for a particular route entry is an IAP, where this indicator is set to “yes” if the destination address is that of an IAP and is otherwise set to “no,” an indicator that indicates whether the destination node (column 1) for a route entry is a leaf node, where this indicator is set to “yes” if the destination is a leaf node and is otherwise set to “no”, a data rate to the next hop node that provides the data rate over the mesh communication links between the node maintaining the routing table 400 and the next hop node towards the destination node, and a precursor list that maintains the list of nodes (or addresses of those nodes) that are using this node to reach the destination node that is specified by destination address for this particular route entry. In one implementation, the route information in the “data rate to the next hop node” column can be referred to as a rate selection table. The precursor list essentially describes the parent-child relationship of this node in a branch of the tree. For example, in a route entry for an intermediate mesh node of the IAP (i.e., route entry having destination address set to that of the IAP), the precursor list will have downlink child mesh nodes which are using the current mesh node to reach the IAP. The precursor list can be created during the route formation as is described in many existing routing protocols such as the AODV routing protocol and MSR protocol described above.

FIG. 5 is flow chart illustrating a method 500 performed at an IAP for improving efficiency and reliability of broadcast transmission in a multi-hop wireless mesh communication network in accordance with some embodiments. To illustrate how methods 500, 600 of FIGS. 5-6 can be implemented in one specific, non-limiting network configuration, methods 500, 600 will be described below with reference to communication of a broadcast packet in the multi-hop wireless mesh communication network 100 described above with reference to FIGS. 1 and 2. As will be explained below with reference to FIG. 2, methods 500, 600 can reduce overhead and/or improve reliability during communication of the broadcast packet.

A broadcast packet can originate from a mesh node 102 within the multi-hop wireless mesh communication network 100, or from an external computing node that is part of the wired network 110. In one scenario, the IAP 106 receives a broadcast packet from an external node in the fixed network 110 that is destined for other mesh nodes in the multi-hop wireless mesh communication network 100 and IAP 106 broadcasts the broadcast packet into the multi-hop wireless mesh communication network 100. The broadcast packet can easily follow the tree structure from IAP 106 to ensure that every mesh node has a path for receiving the broadcast packet.

By contrast, for the broadcast traffic generated or originated by a source mesh node 102 that is part of the multi-hop wireless mesh communication network 100, in accordance with one embodiment, the source mesh node 102 can “unicast” its broadcast packet (that is destined for other mesh nodes in the multi-hop wireless mesh communication network 100) to the IAP 106 even though it is intended to be a broadcast packet. In other words, instead of broadcasting the packet as would be normally done, the source mesh node 102 will unicast its broadcast packet to the IAP 106, and the IAP 106 will then broadcast the packet. As explained below, this increases the overall broadcast efficiency. Each broadcast packet includes a unique broadcast identifier that identifies that packet and can be used by recipients to identify duplicate packets and if necessary discard them. Thus, the IAP 106 can control which packets are discarded.

The method 500 begins at step 510, when the IAP 106 receives a broadcast packet that is destined for other mesh nodes 102-1 through 102-19 in the multi-hop wireless mesh communication network 100. At this point, the IAP 106 has the broadcast packet which it needs to propagate throughout the multi-hop wireless mesh communication network 100. The broadcast packet that is received by the IAP 106 includes a unique broadcast identifier (ID) that will be referred to below as a “first” unique broadcast identifier (ID).

At step 520, the IAP 106 prepares to re-transmit the broadcast packet to the mesh nodes 102-1 . . . 102-19 by performing steps 330 and 340. As described above, in a mesh network that implements any of the routing protocols described above (e.g., the MSR routing protocol), all the mesh nodes 102-1 through 102-19 maintain a route to the IAP 106, and the IAP 106 (and each of the other mesh nodes) store information in a routing table regarding the routes between the IAP 106 and each mesh node 120. Route entries in the routing table will include information that describes a tree structure of the mesh nodes 102 that make up the multi-hop wireless mesh communication network 100 as described in FIG. 4.

At step 530, the IAP 106 determines a list of its downlink child mesh nodes based on the information in its routing table. In one implementation, IAP will find route entries for all the leaf nodes (e.g., in FIG. 4 for entries where the indicator of whether the destination node is an IAP is set to ‘Yes’). The IAP will use the next hop addresses for such entries to create the list of its downlink child mesh nodes.

For better understanding, examples of route entries that can be found in the routing tables for IAP 106 of FIGS. 1 and 2 will now be described, where Table 1 illustrates a routing table maintained at the IAP 106 with some example route entries. In these examples, route information specified in the destination address column and the next hop address column are not shown using actual MAC addresses or IP addresses, but are instead shown using node names from FIGS. 1 and 2 for ease of understanding.

TABLE 1

| | | | | DATA | |
|---|---|---|---|---|---|
| | | | | RATE | |
| | | | IS | TO | |
| | NEXT | IS | DESTINATION | NEXT | |
| DESTINATION | HOP | DESTINATION | A LEAF MESH | HOP | PRECURSOR |
| ADDRESS | ADDRESS | IAP? | NODE? | (MBPS) | LIST |
| Node 18 | Node 1 | No | Yes | 9 | null |
| Node 19 | Node 2 | No | Yes | 12 | null |
| Node 8 | Node 3 | No | No | 48 | null |
| . . . | . . . | . . . | . . . | . . . | . . . |
| . . . | . . . | . . . | . . . | . . . | . . . |

As illustrated by the example route entries in Table 1, the IAP 106 marks each entry in the precursor list column as “null.” In contrast to other mesh nodes, the IAP 106 does not maintain precursor list and therefore all entries therein are marked null. This is because the IAP 106 can determine the next-hop nodes to leaf mesh nodes from other route information in its routing table. For example, the IAP 106 can determine its list of downstream child mesh nodes by looking at route entries for leaf mesh nodes. For example, here the next hop nodes 102-1, 102-2, 102-3, 102-4 toward each of the leaf mesh nodes 102-11, 102-18, 102-19, 102-14, 102-15, 102-9, 102-16, 102-17 are the “downlink child mesh nodes” of the IAP 106. The IAP 106 will choose the lowest of the data rates associated with these next hop nodes, which in this example is 9 Mbps. In another implementation, IAP 106 can simply find the lowest data rate of all its next hop nodes (rather than going through specific leaf mesh node entries). In many scenarios, a next hop in IAP's 106 route table will be serving some leaf mesh node.

In another implementation, IAP can maintain an explicit list of all the leaf mesh nodes in the network and use it in conjunction with the routing table information to find downlink child mesh nodes. For instance, in one implementation, each leaf node can include information in route request (RREQ) messages it transmits to the IAP that indicate to the IAP that a particular node is a leaf node. In the example illustrated in FIG. 1, this list for the IAP 106 specifies addresses of its downlink child mesh nodes 102-1, 102-2, 102-3 and 102-4.

At step 540, the IAP 106 determines which one of the communication links with its downlink child mesh nodes has the lowest data rate. In one implementation, IAP can determine this information from route entries of the leaf nodes. In another implementation, this information can be obtained from its rate selection table. At step 550, IAP re-transmits or broadcasts the broadcast packet at this lowest data rate. In other words, the IAP 106 determines the minimum data rate along the different communication links it shares with each of its downlink child mesh nodes, and then broadcasts the broadcast packet to its downlink child mesh nodes at this minimum data rate.

Using the data rates specified in FIG. 2 as an example, the data rates over the mesh communication links between the IAP 106 and mesh node 102-1, mesh node 102-2, mesh node 102-3 and mesh node 102-4 are 9 Mbps, 12 Mbps, 48 Mbps and 18 Mbps, respectively. To transmit a broadcast packet, the IAP 106 selects minimum link data rate from link rates to its downlink child mesh nodes, and transmits its broadcast packet at 9 megabits per second. Each of the downlink child mesh nodes of the IAP 106 will be guaranteed to receive the broadcast packet when it is transmitted at this lowest data rate because the broadcast packet will travel over a greater distance the lowest data rate (in comparison to it being transmitted at higher data rates). For instance, since IAP 106 broadcasts the packet at 9 megabits per second, mesh node 102-2, mesh node 102-3 and mesh node 102-4 will receive this packet because transmission data rate is less then their individual link data rates. As noted above, in a conventional approach, the IAP 106 would typically transmit a broadcast packet at a system minimum data rate to try and ensure that as many of the mesh nodes 102-1 through 102-19 as possible receive the broadcast packet. By contrast, according to the method 500, the IAP is only concerned about selecting the lowest data rate that will ensure that the broadcast packet reaches each of its downlink child mesh nodes 102-1, 102-2, 102-3 and 102-4. The lowest data rate selected by the IAP 106 will be adequate to ensure that at least each of the downlink child mesh nodes 102-1, 102-2, 102-3 and 102-4 of the IAP 106 will receive the broadcast packet, and even though other mesh nodes 102-5 . . . 102-19 may not or will probably not receive the broadcast packet. At the same time, the lowest data rate along the links between its downlink child mesh nodes will be higher than a system minimum data rate (which would otherwise be used to ensure that the broadcast packet reaches all mesh nodes in the network), and therefore the broadcast packet will actually be transmitted at a data rate greater than the system minimum data rate. As such, in comparison to the conventional approach the overall data rate of the broadcast is increased over the links to the downlink child mesh nodes 102-1, 102-2, 102-3 and 102-4 of the IAP 106. Moreover, overhead and redundancy are substantially reduced since mesh nodes are less likely to receive multiple copies of the same broadcast packet from different sources. As will be described below with reference to steps 410-460 of FIG. 6, each of the downlink child mesh nodes 102-1, 102-2, 102-3 and 102-4 will use a similar method to distribute the broadcast packet to their child mesh nodes.

As noted above, it would also be desirable to improve reliability of broadcast communications. Techniques for doing so will now be described with reference to steps 555 through 597. As described above, the multi-hop wireless mesh communication network 100 includes IAP 106 and a plurality of mesh nodes 102-1 through 102-19, where mesh nodes 102-11, 102-18, 102-19, 102-14, 102-15, 102-9, 102-16, 102-17 are “leaf mesh nodes” meaning that these mesh nodes have no downlink child mesh nodes. All the leaf mesh nodes can explicitly inform the IAP 106 about their leaf mesh node status either (1) periodically by adding this information in a periodic route request (RREQ) message that the mesh nodes send to IAP 106 or (2) by sending an individual message when the status of the mesh node changes to or from being a leaf mesh node. The IAP 106 maintains a list of all the leaf mesh nodes 102-11, 102-18, 102-19, 102-14, 102-15, 102-9, 102-16, 102-17 in the multi-hop wireless mesh communication network 100. IAP 106 performs steps 555 through 595 each of the leaf mesh nodes 102-11, 102-18, 102-19, 102-14, 102-15, 102-9, 102-16, 102-17 maintained in its list.

Upon re-transmitting or broadcasting the broadcast packet at the lowest data rate at step 550, the IAP 106 expects an explicit acknowledgment (ACK) message from each of the leaf mesh nodes 102-11, 102-18, 102-19, 102-14, 102-15, 102-9, 102-16, 102-17 maintained in its list within a certain amount of time. As is also illustrated at step 550, upon re-transmitting or broadcasting the broadcast packet, the IAP 106 can set an acknowledgment (ACK) timer for each of the leaf mesh nodes 102-11, 102-18, 102-19, 102-14, 102-15, 102-9, 102-16, 102-17 maintained in its list. Each ACK timer specifies the amount of time a particular leaf node is given to respond with an ACK message (to indicate that the broadcast packet was successfully received by the particular leaf mesh node) before the IAP 106 selectively retransmits the broadcast packet. In one implementation, the acknowledgment (ACK) timer can be the same for each branch and each leaf mesh node. In another implementation, the acknowledgment (ACK) timer can be different for each leaf mesh node. For instance, in one implementation, the ACK timer for each leaf mesh node can be a function of the number of hops that the leaf mesh node of a particular branch is away from the IAP 106.

At step 555, the IAP selects a leaf mesh node from the list of leaf mesh nodes, and at step 560, determines whether an acknowledgement (ACK) timer for the selected leaf mesh node has expired. If not, the method 500 loops back to step 560. When the acknowledgement (ACK) timer for the selected leaf mesh node has expired, the method 500 proceeds to step 570, where the IAP 106 determines whether an explicit acknowledgement (ACK) message was received from the selected leaf mesh node. Here the term “explicit” is used to differentiate from an implicit ACK message that will be describe below. In accordance with method 500, only leaf mesh nodes send ACK messages to acknowledge reception of the broadcast packet, and in this regard an explicit acknowledgement (ACK) message refers to an acknowledgement (ACK) message received from a leaf mesh node for the broadcast packet.

When the IAP 106 has received an explicit acknowledgement (ACK) message from the selected leaf mesh node, the method 500 proceeds to step 580, where the IAP 106 explicitly determines that the broadcast packet was successfully delivered to the leaf mesh node and implicitly determines that the broadcast packet was successfully delivered to each of the other mesh nodes along a branch/route between the IAP and the selected leaf mesh node. As will be explained below with reference to FIG. 6, acknowledgement by other intermediate mesh nodes along the branch/route between the IAP 106 and the selected leaf mesh node are “implicit” since each intermediate mesh node acknowledges reception of the broadcast packet by forwarding the explicit acknowledgement (ACK) message along the route to the IAP 106 if and only if that intermediate mesh node has a previously received a broadcast packet that includes the first unique broadcast identifier (ID) that matches a broadcast identifier (ID) in the explicit acknowledgement (ACK) message.

When the IAP 106 has not received an explicit acknowledgement (ACK) message from the selected leaf mesh node, the method 500 proceeds to step 590, where the IAP 106 unicasts a special copy of the broadcast packet towards the selected leaf mesh node. This unicast message is “special” in that it will be accepted and/or processed by all the intermediate mesh nodes along the route/branch and forwarded towards the leaf mesh node. For instance, if IAP 106 does not receive an ACK message from leaf mesh node 102-19 before the acknowledgement (ACK) timer for the leaf mesh node 102-19 has expired, the IAP 106 will unicast the original broadcast packet with the destination address of the leaf mesh node 120-19 and the original broadcast ID. Downlink child mesh node 102-2 will check the broadcast ID of this broadcast packet. If the downlink child mesh node 102-2 has previously received a broadcast packet with the same broadcast ID it will forward it to the next hop intermediate mesh node 120-7 along the route to the leaf mesh node 102-19. If downlink child mesh node 102-2 has not previously received a broadcast packet with this broadcast ID, downlink child mesh node 102-2 will process this broadcast packet and forward it to the next hop mesh node 102-7 along the route towards the leaf mesh node 102-19.

Although not illustrated in FIG. 5, in one implementation, the IAP 106 counts the number of leaf mesh nodes that the IAP 106 has not received an ACK message from. The IAP 106 can then determine if the number of unacknowledged leaf mesh nodes exceeds a threshold (either a number or percentage of total leaf mesh nodes). If so, the IAP 106 can either (1) selectively unicast the broadcast packet back to some of the leaf mesh nodes which did not send an ACK message back, or (2) rebroadcast the broadcast packet again to all of its downlink child mesh nodes 102-1, 102-2, 102-3 and 102-4 for retransmission to all mesh nodes 120-5 . . . 120-19. In the latter case, the mesh nodes may compare a broadcast ID to those received in previous broadcast packets, and if a particular mesh node receives duplicate copies of the broadcast packet, then the particular mesh node can decide whether to discard and/or forward the broadcast packet.

Following step 580 or 590, the method 500 proceeds to step 595, where the IAP 106 determines whether the selected leaf mesh node is the last leaf mesh node in the list of leaf mesh nodes. If so, the method 500 ends at step 597. If not, then method 500 loops back to step 555, where the IAP 106 selects the next leaf mesh node from the list of leaf mesh nodes and then repeats steps 560 through 595 with respect to the currently selected leaf mesh node. Steps 555-595 repeat until the IAP evaluates the last leaf mesh node in the list of leaf mesh nodes, at which point the method 500 ends at step 597.

FIG. 6 is flow chart illustrating a method 600 performed at an intermediate mesh node or leaf mesh node for improving efficiency and reliability of broadcast transmission in a multi-hop wireless mesh communication network 100 in accordance with some embodiments.

Method 600 starts at step 605 and is performed by each child mesh node upon receiving a broadcast packet either from the IAP 106 or any other parent mesh node in the multi-hop wireless mesh communication network 100 at step 610. Method 600 will be repeated by the all the downlink child mesh nodes until the broadcast packet reaches the leaf mesh nodes 102-11, 102-18, 102-19, 102-14, 102-15, 102-9, 102-16, 102-17.

Upon receiving the broadcast packet from a parent mesh node at a current child mesh node, at step 620, the current child mesh node determines whether it is a leaf mesh node. The current child mesh node can determine whether or not it is a leaf mesh node by checking if it has any downlink child mesh nodes. In one embodiment, the current child mesh node determines whether it is a leaf mesh node by: looking up a route entry for the IAP in its routing table (i.e., the routing table of the current mesh node), and determining whether a precursor list corresponding to the route entry for the IAP specifies nodes. When the precursor list corresponding to the route entry for the IAP does not specify any nodes, then the current child mesh node is a leaf mesh node since it does not have any downlink mesh nodes. By contrast, when the precursor list corresponding to the route entry for the IAP specifies at least one node, then the current child mesh node is not a leaf mesh node since it has downlink mesh nodes. To explain further, a leaf mesh node is the node which is at the bottom of the tree and has no entries in its precursor list for the route to IAP 106. In other words, there are no downlink mesh nodes that are using this leaf mesh node to reach IAP. If there are no entries in this precursor list, then the current child mesh node is a leaf mesh node and method 600 proceeds to step 655; otherwise the current child mesh node is a non-leaf or intermediate mesh node and method 600 proceeds to step 630.

When the current child mesh node is not a leaf mesh node, current child mesh node performs steps 630 through 652. At step 630, the current child mesh node prepares to re-transmit the broadcast packet and performs steps 640 and 650. At step 640, the current child mesh node determines its downlink child mesh nodes. In one embodiment, the current child mesh node determines its downlink child mesh nodes by: looking up a route entry for the IAP in its routing table (i.e., the routing table of the current mesh node), and determining nodes listed in a precursor list corresponding to the route entry for the IAP. In other words, the nodes listed in the precursor list (corresponding to the route entry for the IAP) are downlink child mesh nodes of the current mesh node. In one implementation, where the routing table 400 of FIG. 4 is used, the current mesh node identifies the route entry for the IAP by finding an indicator that the destination node is an IAP (i.e., is set to ‘Yes’). For this route entry, it will check the precursor list to determine its downlink child mesh nodes. It will then determine the lowest data rate between itself and each of its downlink child mesh nodes. In this regard, it should be noted that each current child mesh node determines this lowest data rate independently of any other mesh nodes that are also re-transmitting the broadcast packet.

For better understanding of step 640, examples of route entries that can be found in the routing tables Node 102-10 of FIGS. 1 and 2 will now be described, where Table 2 illustrates another routing table maintained at node 10 102-10 with some example route entries. In these examples, route information specified in the destination address column and the next hop address column are not shown using actual MAC addresses or IP addresses, but are instead shown using node names from FIGS. 1 and 2 for ease of understanding.

For instance, as illustrated by the example route entries for intermediate mesh node 102-10 of FIG. 2, the intermediate mesh node 102-10 can determine its downlink child mesh nodes by looking at a route entry of the IAP, specifically the precursor list of the route entry for the IAP.

TABLE 2

| | | | | DATA | |
|---|---|---|---|---|---|
| | | | | RATE | |
| | | | IS | TO | |
| | NEXT | IS | DESTINATION | NEXT | |
| DESTINATION | HOP | DESTINATION | A LEAF MESH | HOP | PRECURSOR |
| ADDRESS | ADDRESS | IAP? | NODE? | (MBPS) | LIST |
| Node 17 | Node 17 | No | Yes | 48 | Node 4 |
| IAP | Node 4 | Yes | No | 48 | Node 16, |
| | | | | | Node 17 |
| Node 16 | Node 16 | No | Yes | 36 | Node 4 |
| . . . | . . . | . . . | . . . | . . . | . . . |
| . . . | . . . | . . . | . . . | . . . | . . . |

In other words, the intermediate mesh node 102-10 can determine its downlink child mesh nodes by looking up a route entry for the IAP in the routing table since, by definition, the nodes listed in the precursor list of the route entry for the IAP are downlink child mesh nodes of the intermediate mesh node 102-10. In this example in Table 2, intermediate mesh node 102-10 will look at precursor list for under the route entry to for the IAP and find leaf mesh nodes 102-16, 102-17. These nodes, which are the downlink child mesh nodes for intermediate mesh node 102-10. Intermediate mesh node 102-10 will then select the minimum of the link data rates for leaf mesh nodes 102-16, 102-17, which in this example is 36 Mbps.

At step 652, the current child mesh node re-transmits the broadcast packet at the lowest data rate determined at step 650. As described above, when the broadcast packet is re-transmitted at this lowest data rate, each of the downlink child mesh nodes of the current child mesh node will be guaranteed to receive the broadcast packet even though other mesh nodes may not receive it. Thus, instead of sending the broadcast packet at the basic rate (1 or 2 megabits per second for IEEE 802.11b, 6 megabits per second for IEEE 802.11a) the current child mesh node re-transmits the broadcast packet at the minimum prevailing date rate between the current child mesh node and its relevant downlink child mesh nodes specified in its precursor list such that the broadcast traffic follows the tree structure. For example, mesh node 102-1 will select minimum link data rate from all its downlink child mesh nodes 102-5, 102-6, and transmit the broadcast packet at 24 megabits per second. Each of the mesh nodes 102-1, 102-2, 102-3 102-4 will then determine downlink child mesh nodes from its precursor list and repeat the process. This process is repeated until a leaf mesh node receives the broadcast packet. Thus, using the improved broadcast methods 400, 500, there will be one transmission at 9 megabits per second, two transmissions at 12 megabits per second, one transmission at 18 Mbps, one transmission at 24 megabits per second, six transmissions at 36 megabits per second and one transmission at 48 megabits per second. Thus, the number of transmissions is reduced since seven leaf mesh nodes do not broadcast. In addition, many of the individual nodes such as node 102-1 are transmitting at 24 Mbps rather than 6 Mbps, which represents are significant improvement.

By contrast, when the current child mesh node determines that it is a leaf mesh node at step 620, then method 600 proceeds with steps 455 through 485. In these steps, the current child mesh node will be referred to below as a “current leaf mesh node.” At step 655, the current leaf mesh node determines, from its routing table, a route from the current leaf mesh node to the IAP 106, and at step 660, generates and unicasts an acknowledgement (ACK) message along the route to the IAP 106. The acknowledgement (ACK) message includes a broadcast identifier (ID) that is identical to the first unique broadcast ID provided in the broadcast packet. It is noted that the current leaf mesh node does not retransmit the broadcast packet.

Method 600 continues at step 670, where an intermediate mesh node along the route between the current leaf mesh node and the IAP 106 receives the acknowledgement (ACK) message transmitted by the current leaf mesh node. At step 675, the intermediate mesh node determines whether the intermediate mesh node has previously received a broadcast packet having the first unique broadcast identifier (ID) that matches the broadcast identifier in the acknowledgement (ACK) message from the current leaf mesh node. For instance, in one implementation of step 675, the intermediate mesh node compares the broadcast identifier (ID) from the ACK message to a list of broadcast identifiers (IDs) from broadcast packets previously received by the intermediate mesh node, and determines whether the intermediate mesh node has previously received a broadcast packet having a broadcast identifier (ID) (i.e., the first unique broadcast identifier (ID)) that matches the broadcast identifier (ID) in the acknowledgement (ACK) message from the current leaf mesh node.

When the broadcast identifier in the acknowledgement (ACK) message from the current leaf mesh node matches a broadcast identifier (ID) (i.e., the first unique broadcast identifier (ID)) from the broadcast packet that the intermediate mesh node has previously received, the method 600 proceeds to step 680, where the intermediate mesh node forwards the acknowledgement (ACK) message to the next hop mesh node along the route to the IAP 106. In other words, when the intermediate mesh node has previously received the broadcast packet having the first unique broadcast identifier (ID) and it matches the broadcast identifier in the acknowledgement (ACK) message from the current leaf mesh node, the intermediate mesh node forwards the acknowledgement (ACK) message received from the current leaf mesh node to the next hop mesh node along the route to the IAP 106. This step ensures that all the mesh nodes in a branch have received the broadcast packet since they have previously received the first unique broadcast ID that is included in the ACK message.

When the broadcast identifier in the acknowledgement (ACK) message from the current leaf mesh node does not match a broadcast identifier (ID) that the intermediate mesh node has previously received, this means that the intermediate mesh node has not received the broadcast packet identified by the broadcast IA in the ACK message. As such, the method 600 proceeds to step 685, where the intermediate mesh node drops the acknowledgement (ACK) message received from the current leaf mesh node. In other words, when the intermediate mesh node has not previously received a broadcast packet having the first unique broadcast identifier (ID) that matches the broadcast identifier (ID) in the acknowledgement (ACK) message from the current leaf mesh node, the intermediate mesh node drops the acknowledgement (ACK) message.

Although not illustrated in FIG. 6, each intermediate mesh node along the route to IAP from the current leaf mesh node performs the processing steps 470 through 485.

The processing performed at steps 455-485 is repeated by each of the leaf mesh nodes. As noted above, upon receiving the broadcast packet, the leaf mesh nodes 102-11, 102-18, 102-19, 102-14, 102-15, 102-9, 102-16, 102-17 will not rebroadcast this packet since their respective precursor lists to the IAP 106 will be empty since they have no downlink child mesh nodes specified. Instead, the leaf mesh nodes 102-11, 102-18, 102-19, 102-14, 102-15, 102-9, 102-16 and 102-17 will construct a unicast ACK message with the broadcast ID of the received broadcast packet and then unicast the ACK message back to IAP 106. For example, leaf mesh node 102-19 will construct an ACK message with the broadcast ID of the received broadcast packet and with destination address of IAP 106, and then unicast its ACK message back along a route towards the IAP 106. Upon receiving the unicast ACK message, intermediate mesh node 102-13 will check if it has received a broadcast packet with the broadcast ID specified in the ACK message. If intermediate mesh node 102-13 has previously received a broadcast packet with this broadcast ID, it will forward the ACK message along the route to the IAP, but if it has not previously received a broadcast packet with this broadcast ID, then intermediate mesh node 102-13 will drop the ACK message. Intermediate mesh nodes 102-7 and 102-2 will then perform similar processing. Reception of this packet at IAP 106 provides an explicit acknowledgement (ACK) that leaf mesh node 102-19 received the broadcast packet, and an implicit acknowledgement (ACK) that each of the intermediate mesh nodes 102-13, 102-7, 102-2 along the branch/route to leaf mesh node 102-19 also received the broadcast packet.

Thus, using the improved acknowledgement (ACK) methods 400, 500, reliability of broadcast communications can be improved by only requiring ACK messages from leaf mesh nodes. For instance, in the example above, if each of the eight leafmesh nodes 102-11, 102-18, 102-19, 102-14, 102-15, 102-9, 102-16 and 102-17 transmits a 20 byte ACK message or packet, it would take approximately 203 microseconds of overhead to implement the ACK mechanism. In other words, implementing the ACK mechanism in conjunction with this new broadcast methodology, takes a small fraction of total time.

Thus, numerous embodiments have been described that can improve efficiency of broadcast transmissions in a multi-hop wireless mesh communication network by reducing the overall number of broadcast transmissions and increasing the average data rate of the broadcast transmissions. In addition, in other embodiments, the overall reliability of broadcast transmissions in a multi-hop wireless mesh communication network can be improved via acknowledgement mechanisms.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for communicating a broadcast packet in a multi-hop wireless mesh communication network comprising an intelligent access point (IAP) and a plurality of mesh nodes, the method comprising:
maintaining, at the IAP, a first routing table comprising a plurality of first route entries, and first route information for each first route entry;
unicasting, from a source mesh node to the IAP, a broadcast packet that is destined for other mesh nodes in the multi-hop wireless mesh communication network;
receiving, at the IAP, the broadcast packet, and adding a first unique broadcast identifier (ID) to the broadcast packet;
determining, at the IAP based on the first route information provided in the first routing table stored at the IAP, a list of downlink child mesh nodes of the IAP;
determining, at the IAP, a first lowest data rate between the IAP and each of the downlink child mesh nodes of the IAP; and
re-transmitting the broadcast packet from the IAP at the first lowest data rate between the IAP and each of the downlink child mesh nodes of the IAP.

2. A method according to claim 1, wherein the plurality of mesh nodes include a current child mesh node and at least one leaf mesh node, further comprising:
maintaining, at the current child mesh node, a second routing table comprising a plurality of second route entries, and second route information for each second route entry;
receiving the broadcast packet from a parent mesh node at the current child mesh node;
determining, at the current child mesh node, whether the current child mesh node is a leaf mesh node; and
if the current child mesh node is not a leaf mesh node:
determining, at the current child mesh node, downlink child mesh nodes of the current child mesh node;
determining, at the current child mesh node, another lowest data rate between the current child mesh node and each of the downlink child mesh nodes of the current child mesh node;
re-transmitting the broadcast packet from the current child mesh node at the other lowest data rate between the current child mesh node and each of the downlink child mesh nodes of the current child mesh node.

3. A method according to claim 2, wherein the step of determining, at the current child mesh node, whether the current child mesh node is a leaf mesh node, comprises:
looking up a second route entry for the IAP in the second routing table of the current child mesh node; and
determining whether a precursor list corresponding to the second route entry for the IAP specifies nodes, and
when the precursor list corresponding to the second route entry for the IAP specifies at least one node, determining that the current child mesh node is not a leaf mesh node.

4. A method according to claim 2, wherein the step of determining, at the current child mesh node, downlink child mesh nodes of the current child mesh node, comprises:
looking up a second route entry for the IAP in the second routing table of the current mesh node; and
determining nodes listed in a precursor list corresponding to the second route entry for the IAP, wherein the nodes listed in the precursor list corresponding to the second route entry for the IAP are downlink child mesh nodes of the current mesh node

5. A method according to claim 1, wherein the first route information for each first route entry comprises:
a destination address of a destination node of the broadcast packet,
a next hop address of a next hop node to reach the destination node,
an indicator that indicates whether the destination address of the destination node is that of an IAP,
an indicator that indicates whether the destination address of the destination node is that of a leaf mesh node, and
a data rate to the next hop node that provides the data rate over the mesh communication links between the IAP and the next hop node towards the destination node.

6. A method according to claim 5, wherein the step of determining, at the IAP based on route information provided in the first routing table stored at the IAP, a list of downlink child mesh nodes of the IAP, comprises:
determining, at the IAP based on the first route information provided in the first routing table stored at the IAP, a list of downlink child mesh nodes of the IAP, wherein the next hop nodes specified in the first routing table are the list of downlink child mesh nodes of the IAP.

7. A method according to claim 4, wherein the second route information for each second route entry comprises:
a destination address of a destination node of the broadcast packet,
a next hop address of a next hop node to reach the destination node,
an indicator that indicates whether the destination address of the destination node is that of an IAP,
an indicator that indicates whether the destination address of the destination node is that of a leaf mesh node,
a data rate to the next hop node that provides the data rate over the mesh communication links between the current child mesh node and the next hop node towards the destination node, and
a precursor list that maintains information regarding the list of nodes that are using the current child mesh node to reach the destination node that is specified by the destination address for each particular second route entry, and wherein the precursor list route entry corresponding to the IAP specifies a list of downlink child mesh nodes of the current child mesh node.

8. A multi-hop wireless mesh communication network comprising a plurality of mesh nodes, comprising:
a source mesh node that unicasts a broadcast packet that is ultimately destined for other mesh nodes in the multi-hop wireless mesh communication network;
an intelligent access point (IAP):
wherein the IAP is designed to maintain a first routing table comprising a plurality of first route entries, and first route information for each first route entry;
wherein the IAP is designed to receive the broadcast packet from the source mesh node; and to add a first unique broadcast identifier (ID) to the broadcast packet;
wherein the IAP is designed to determine, based on the first route information maintained in the first routing table, a list of downlink child mesh nodes of the IAP; and to determine a first lowest data rate between the IAP and each of the downlink child mesh nodes of the IAP; and
wherein the IAP is designed to re-transmit the broadcast packet from the IAP at the first lowest data rate between the IAP and each of the downlink child mesh nodes of the IAP.

9. A multi-hop wireless mesh communication network according to claim 8, wherein the plurality of mesh nodes further comprise:
a parent mesh node designed to receive the broadcast packet that was re-transmitted by the IAP; and
a current child mesh node designed to: maintain a second routing table comprising a plurality of second route entries, and second route information for each second route entry; receive the broadcast packet from the parent mesh node, and determine whether the current child mesh node is a leaf mesh node; and
if the current child mesh node is not a leaf mesh node, wherein the current child mesh node is further designed to: determine downlink child mesh nodes of the current child mesh node; determine another lowest data rate between the current child mesh node and each of the downlink child mesh nodes of the current child mesh node; and re-transmit the broadcast packet from the current child mesh node at the other lowest data rate between the current child mesh node and each of the downlink child mesh nodes of the current child mesh node.

10. A multi-hop wireless mesh communication network according to claim 9, wherein the current child mesh node determines whether the current child mesh node is a leaf mesh node by looking up a second route entry for the IAP in the second routing table of the current child mesh node; and determining whether a precursor list corresponding to the second route entry for the IAP specifies nodes, and
wherein the current child mesh node is further designed to determine that the current child mesh node is not a leaf mesh node when the precursor list corresponding to the second route entry for the IAP specifies at least one node.

11. A multi-hop wireless mesh communication network according to claim 9, wherein the second route information for each second route entry comprises:
a destination address of a destination node of the broadcast packet,
a next hop address of a next hop node to reach the destination node,
an indicator that indicates whether the destination address of the destination node is that of an IAP,
an indicator that indicates whether the destination address of the destination node is that of a leaf mesh node,
a data rate to the next hop node that provides the data rate over the mesh communication links between the current child mesh node and the next hop node towards the destination node, and
a precursor list that maintains information regarding the list of nodes that are using the current child mesh node to reach the destination node that is specified by the destination address for each particular second route entry, and wherein the precursor list route entry corresponding to the IAP specifies a list of downlink child mesh nodes of the current child mesh node.

12. A multi-hop wireless mesh communication network according to claim 11, wherein the current child mesh node determines downlink child mesh nodes of the current child mesh node by looking up a second route entry for the IAP in the second routing table; and determining nodes listed in a precursor list corresponding to the second route entry for the IAP,
wherein the nodes listed in the precursor list corresponding to the second route entry for the IAP are downlink child mesh nodes of the current mesh node.

13. A multi-hop wireless mesh communication network according to claim 8, wherein the first route information for each first route entry comprises:
a destination address of a destination node of the broadcast packet,
a next hop address of a next hop node to reach the destination node,
an indicator that indicates whether the destination address of the destination node is that of an IAP,
an indicator that indicates whether the destination address of the destination node is that of a leaf mesh node, and
a data rate to the next hop node that provides the data rate over the mesh communication links between the IAP and the next hop node towards the destination node.

14. A multi-hop wireless mesh communication network according to claim 13, wherein the next hop nodes specified in the route information of the first routing table are the list of downlink child mesh nodes of the IAP.

15. An intelligent access point (IAP) designed to operate within multi-hop wireless mesh communication network comprising a plurality of mesh nodes, the IAP comprising:
a processor designed to maintain a first routing table comprising a plurality of first route entries, and first route information for each first route entry;
a receiver designed to receive a broadcast packet from unicast from source mesh node, wherein the broadcast packet is ultimately destined for other mesh nodes in the multi-hop wireless mesh communication network;
wherein the processor is further designed to add a first unique broadcast identifier (ID) to the broadcast packet; to determine, based on route information maintained in the first routing table, a list of downlink child mesh nodes of the IAP; and to determine a first lowest data rate between the IAP and each of the downlink child mesh nodes of the IAP; and
a transmitter designed to re-transmit the broadcast packet from the IAP at the first lowest data rate between the IAP and each of the downlink child mesh nodes of the IAP.

16. A method for communicating a broadcast packet in a multi-hop wireless mesh communication network comprising an intelligent access point (IAP) and a plurality of mesh nodes, the method comprising:
maintaining, at the IAP, a first routing table comprising a plurality of first route entries, and first route information for each first route entry;
receiving, at the IAP, a broadcast packet;
determining, at the IAP based on the first route information provided in the first routing table stored at the IAP, a list of downlink child mesh nodes of the IAP;
determining, at the IAP, a first lowest data rate between the IAP and each of the downlink child mesh nodes of the IAP; and
re-transmitting the broadcast packet from the IAP at the first lowest data rate between the IAP and each of the downlink child mesh nodes of the IAP.
